(19) United States
(12) Patent Application Publication
(10) Pub. No.: US 2009/0255647 A1
(43) Pub. Date: Oct. 15, 2009

(54) INFANT CARE ENSEMBLE

(76) Inventor: LYNINN LIM, Houston, TX (US)

Correspondence Address: James Ray & Associates, 2640 Pitcairn Road, Monroeville, PA, 15146, US

(21) Appl. No.: 12/419,332

(22) Filed: Apr. 7, 2009

Related U.S. Application Data
(60) Provisional application No. 61/043,420, filed on Apr. 9, 2008.

(51) Int. Cl. F25B 29/00; F27D 11/00

(52) U.S. Cl. 165/61; 219/386

(57) ABSTRACT

An infant care ensemble includes a storage device including a first housing having at least one of a cooling mechanism, a first heating mechanism, and a combination thereof for at least one of cooling an interior portion thereof, warming an interior portion of thereof, cooling predetermined items therein, warming predetermined items therein, and a combination thereof. A first power source is connected to at least one of such cooling mechanism, such first heating mechanism, and a combination thereof. A bottle warming device is releasably engageable with such storage device and includes a second housing for housing a predetermined baby bottle. A second heating mechanism heats at least one of an interior portion of such second housing, such baby bottle, and a combination thereof. A second power source supplies power to such second heating mechanism. First and second switch mechanisms turn on and off such first and second power sources.

### CROSS REFERENCE TO RELATED APPLICATION

This patent application is related to and claims priority from U.S. Provisional Patent Application Ser. No. 61/043,420 filed Apr. 9, 2008.

### FIELD OF THE INVENTION

The present invention relates, in general, to bottle warming and cooling devices and, more particularly, this invention relates to a portable infant care ensemble which includes a bottle storage device within which cold bottles may be stored, a warming device for selectively warming a predetermined bottle and at least one storage compartment for storing a plurality of predetermined infant care items.

### BACKGROUND OF THE INVENTION

Prior to the conception and development of the present invention, diaper bags, as are generally well known in the prior art, have been used by parents to transport diapers, toys, bottles of formula, breast milk, milk, etc. and the like. Unfortunately, such diaper bags often fail to keep cold bottles cold and such diaper bags do not provide a way for parents to warm bottles. Very young infants have a difficult time drinking from a cold bottle. Drinking from cold bottles may result in stomach upset and vomiting. Furthermore, cold bottles may be refused by an infant and such infant may end up crying in frustration resulting in parents and caregivers becoming emotionally taxed and distracted.

Specifically of interest to the present invention are the following: Katayev, U.S. Pat. No. 5,208,896 discloses an electrically warmed baby bottle and recharging system; the baby bottle includes heating wires embedded in the walls thereof.

Carriere, U.S. Publication No. 2006/0283205 discloses a diaper bag which includes insulated compartments for receiving hot and cold packs.

Zorn, U.S. Publication No. 2002/0026798 discloses a rolling cooler bag which utilizes an active cooling device with a heat exchange.

None of the cited prior art provides the benefits attendant the present invention.

### SUMMARY OF THE INVENTION

The present invention provides an infant care ensemble for storing and transporting infant care items. Such infant care ensemble includes a storage device. Such storage device includes a first housing having a first predetermined size and a first predetermined shape for receiving and storing predetermined items therein. At least one of a cooling means, a first heating means, and a combination thereof is disposed at least one of on and within such first housing for at least one of cooling an interior portion of such first housing, warming an interior portion of such first housing, cooling such predetermined items stored within such first housing, warming such predetermined items stored within such first housing, and a combination thereof. A first power source is operably connected to such at least one of such cooling means, such first heating means, and such combination thereof for supplying power thereto. A first switch means is disposed intermediate such first power source and such at least one of such cooling means, such first heating means, and such combination thereof for selectively turning such power source on and off. A bottle warming device is releasably engageable with such storage device. Such bottle warming device includes a second housing having a second predetermined size and a second predetermined shape for housing at least a predetermined lower portion of a predetermined baby bottle. A second heating means is operably disposed at least one of on such second housing, within such second housing, and a combination thereof for heating at least one of an interior portion of such second housing, such predetermined lower portion of such predetermined baby bottle, and a combination thereof. A second power source is operably connected to such second heating means for supplying power thereto. A switch means is disposed intermediate such second heating means and such second power source for selectively turning such power source on and off.

### OBJECTS OF THE INVENTION

It is, therefore, one of the primary objects of the present invention to provide an infant care ensemble which includes a bottle warming device, a bottle cooling device, and a storage compartment for storing a plurality of predetermined infant care items.

Another object of the present invention is to provide an infant care ensemble which includes a detachable bottle warming device which is capable of warming a bottle of infant formula to a predetermined temperature.

Still another object of the present invention is to provide a portable, lightweight, convenient to use bottle warming device which can utilize at least one of AC and DC power to warm an infant's bottle.

Yet another object of the present invention is to provide a device which can be utilized to bring a predetermined bottle to a predetermined temperature; such device having a range of temperatures which may be selected by a user.

An additional object of the present invention is to provide an infant care ensemble which includes a bottle warming device and a separate cooling device each of which may be powered by AC and DC power.

It is still an additional object of the present invention is to provide an infant care ensemble which includes a bottle warming device and a separate cooling device for receiving and storing bottles and each of such bottle warming device and such bottle cooling device being powered by a battery, such batteries being chargeable from an automobile battery.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention; the device is illustrated with a plurality of baby bottles situated in the first housing and an adapter is depicted alongside such first housing, the adapter is for use with either a standard wall electrical outlet or for use in charging the battery of the device via an automobile power from an automobile battery. A mesh compartment is illustrated on one side of such first housing for receiving at least one of such second housing, such predetermined portion of a predetermined baby bottle, a predetermined item, such as a cell phone or other item, and a combination thereof.

FIG. 2 is a partial perspective view of the invention according to one embodiment of the invention in which such first housing is illustrated having such second housing disposed within such mesh compartment disposed on such outside of such first housing, such second housing is a wrap and envelops a lower portion of a predetermined baby bottle. In this manner, such first housing may be used to store and cool baby bottles and food items and such second housing may be implemented to warm such baby bottles one at a time. Such second housing may also be used to warm jars or other containers of baby food and other food items.

FIG. 3 is a partial perspective view of the invention according to one embodiment of the invention in which an adapter is illustrated for use in supplying power to such invention and/or in charging at least one of such first power supply, such second power supply, and a combination thereof.

FIG. 4 is a partial perspective view of the invention according to one embodiment of the invention in which the second housing is illustrated wrapped around a predetermined portion of a baby bottle and secured in place via a securing means.

FIG. 5 is a partial perspective view of the invention according to one embodiment of the invention in which the second housing is illustrated in a position ready to be wrapped around a predetermined baby bottle; the second power source is not depicted in FIG. 4 but may be a battery disposed on an outer portion of such second housing, such second heating means may be heatable wires (not shown) disposed within such second housing.

FIG. 6 is a partial perspective view of the invention according to one embodiment of the invention in which the second housing is illustrated in a position ready to be wrapped around a predetermined baby bottle; the power source in FIG. 4 is illustrated as a battery which is situated below such baby bottle.

FIG. 7 is a partial perspective view of the invention according to one embodiment of the invention.

FIG. 8 is a partial perspective view of the invention according to one embodiment of the invention.

FIG. 9 is a partial perspective view of the invention according to one embodiment of the invention.

FIG. 10 is a partial perspective view of the invention according to one embodiment of the invention.

FIG. 11 is a partial perspective view of the invention according to one embodiment of the invention.

FIG. 12 is a partial perspective view of the invention according to one embodiment of the invention.

FIG. 13 is a partial perspective view of the invention according to one embodiment of the invention in which such adapter is plugged into such second housing for at least one of charging and supplying power to such second power source.

FIG. 14 is a partial perspective view of the invention according to one embodiment of the invention.

FIG. 15 is a partial perspective view of the invention according to one embodiment of the invention.

FIG. 16 is a schematic view of the storage device; such view depicts the device as including both a cooling means and a first heating means.

FIG. 17 is a schematic view of the warming device.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

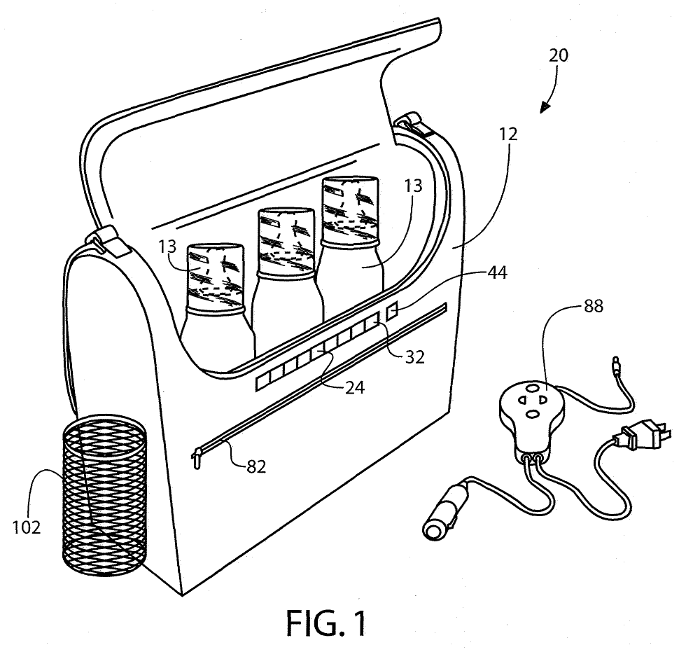

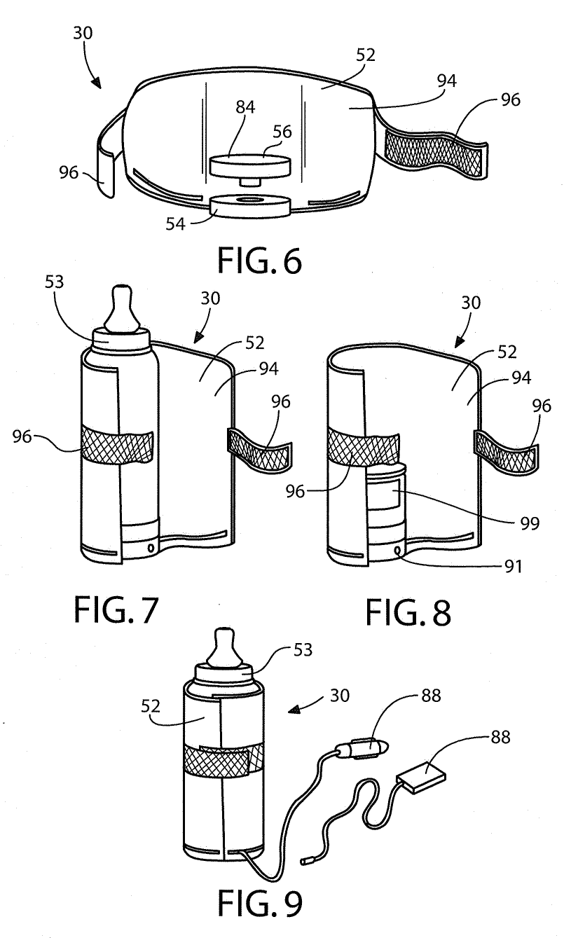

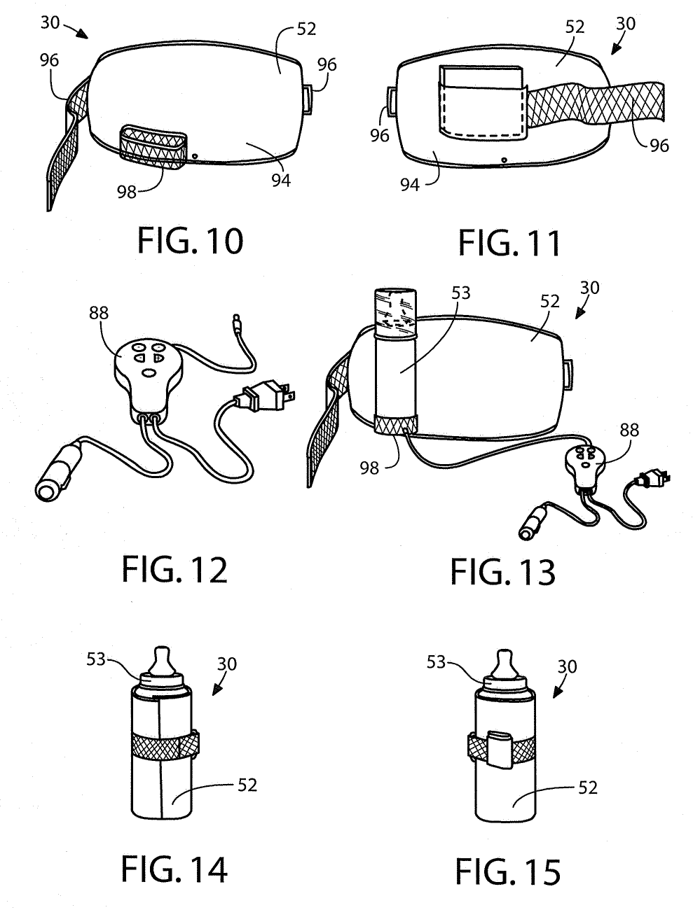

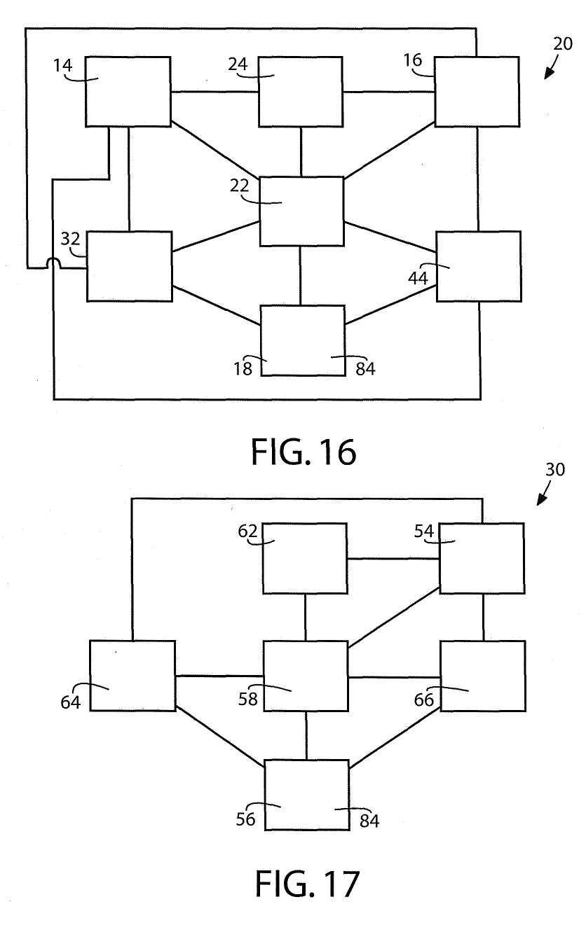

Reference is now made, more particularly, to FIGS. 1-17.

An infant care ensemble, generally designated 10 for storing and transporting infant care items is provided.

Such infant care ensemble 10 includes a storage device, generally designated 20.

Such storage device 20 includes a first housing 12 having a first predetermined size and a first predetermined shape for receiving and storing predetermined items 13 therein. Such predetermined items may be any type of items necessary for care of an infant, however, the storage device is particularly useful for receiving and storing consumable items and containers containing consumable items such as baby bottles, infant food, warm and/or cold food, snacks, drinks, fruit, and the like. As illustrated in FIG. 1, such predetermined items 13 are depicted as baby bottles.

At least one of a cooling means 14, a first heating means 16, and a combination thereof is disposed at least one of on and within such first housing 12 for at least one of cooling an interior portion of such first housing 12, warming an interior portion of such first housing 12, cooling such predetermined items 13 stored within such first housing 12, warming such predetermined items 13 stored within such first housing 12, and a combination thereof.

A first power source 18 is operably connected to such at least one of such cooling means 14, such first heating means 16, and such combination thereof for supplying power thereto.

A first switch means 22 is disposed intermediate such first power source 18 and such at least one of such cooling means 14, such first heating means 16, and such combination thereof for selectively turning such first power source 18 on and off.

It is presently preferred that such storage device 20 further includes a first control means 24 disposed on such first housing 12 and operably connected to such at least one of such cooling means 14, such first heating means 16, and such combination thereof, such first power source 18, and such first switch means 22, for controlling a temperature of at least one of such at least one of such cooling means 14, such first heating means 16, and such combination thereof, an interior portion of such first housing 12, such predetermined items 13 stored within such first housing 12, and a combination thereof.

It is presently preferred that such storage device 20 further includes a first timing means 32 disposed on such first housing 12 and operably connected to such at least one of such cooling means 14, such first heating means 16, and such combination thereof, such first power source 18, and such first switch means 22 for automatically turning off power to such at least one of such cooling means 14, such first heating means 16, and such combination thereof when a predetermined temperature is reached by at least one of such at least one of such cooling means 14, such first heating means 16, and such combination thereof, an interior portion of such first housing 12, such predetermined items 13 stored within such first housing 12, and a combination thereof.

It is further presently preferred that such storage device 20 further includes a first indicating means 44 disposed on such first housing 12 and operably connected to such at least one of such cooling means 14, such first heating means 16, and such combination thereof, such first power source 18, and such first switch means 22 for indicating that at least one of such at least one of such cooling means 14, such first heating means 16, and such combination thereof, and such interior portion of such first housing, such predetermined items stored within such first housing 12, and a combination thereof has reached such predetermined temperature.

A bottle warming device, generally designated 30 is releasably engageable with such storage device 20. Such bottle warming device 30 includes a second housing 52 having a second predetermined size and a second predetermined shape for housing at least a predetermined lower portion of a predetermined baby bottle 53. Other items may also be placed within such second housing 52. For example, as illustrated in FIG. 8, a jar of baby food 99 is ready to be enveloped in such second housing 52.

A second heating means 54 is operably disposed at least one of on such second housing 52, within such second housing 52, and a combination thereof for heating at least one of an interior portion of such second housing 52, such predetermined lower portion of such predetermined baby bottle 53, and a combination thereof.

A second power source 56 is operably connected to such second heating means 54 for supplying power thereto.

A second switch means 58 is disposed intermediate such second heating means 54 and such second power source 56 for selectively turning such second power source 56 on and off.

It is further presently preferred that such bottle warming device 30 further includes a second control means 62 operably connected to such second housing 52, such second heating means 54, such second power source 56, and such second switch means 58 for controlling a temperature of at least one of such second heating means 54, an interior portion of such second housing 52, such predetermined portion of such predetermined baby bottle 53 disposed within such second housing 52, and a combination thereof.

It is presently preferred that such bottle warming device 30 further includes a second timing means 64 operably connected to such second heating means 54, such second power source 56, and such second switch means 58 for automatically turning off power to such second heating means 54 when a predetermined temperature has been reached by at least one of such second heating means 54, an interior portion of such second housing 52, such predetermined portion of such predetermined baby bottle 53 housed within such second housing 52, and a combination thereof.

It is further presently preferred that such bottle warming device 30 further includes a second indicating means 66 disposed on such second housing 52 and operably connected to such second heating means 54, such second power source 56, and such second switch means 58 for indicating that at least one of such second heating means 54, an interior portion of such second housing, and a combination thereof has reached a predetermined temperature.

It is presently preferred that such first power source 18 and such second power source 56 are each at least one of AC and DC power. It is further presently preferred that such first power source 18 and such second power source 56 are each at least one battery 84. It is presently preferred that such at least one battery 84 is rechargeable.

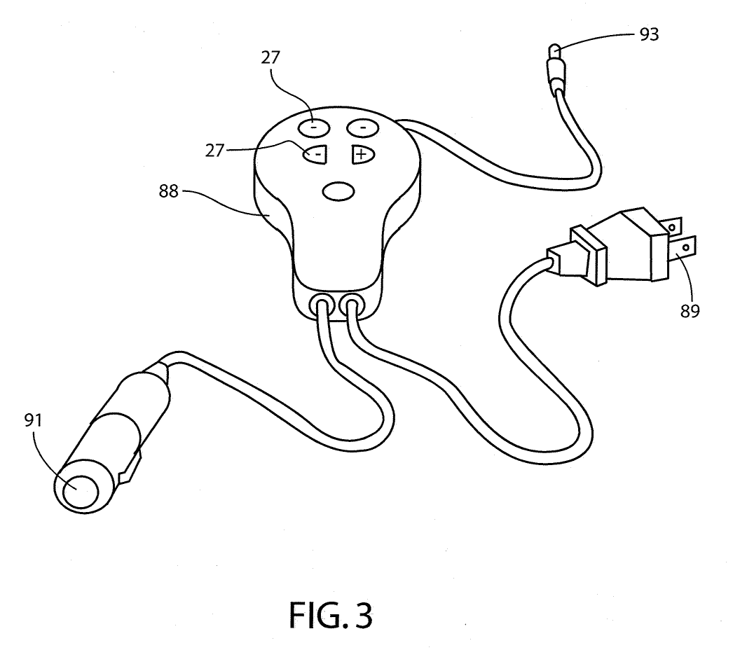

It is presently preferred that such infant care ensemble 10 further includes at least one adapter 88 engageable with such of such at least one battery 84 and with at least one of an electrical outlet (not shown), an automobile battery (not shown), and a combination thereof for recharging such at least one battery 84. Such at least one adapter 88 may be an interchangeable device operable to receive power from various sources, for example, the adapter 88, as illustrated in FIG. 3, includes a plug 89 for receiving power from a typical electrical socket and includes an auxiliary plug 91 for receiving power from an automobile battery and a transfer plug 93 for insertion into a port 91 on at least one of such storage device 20, such warming device 30 and a combination thereof. Additionally, such adapter 88 may include controls 27 which will allow a user to raise or lower the temperature of the cooling and/or warming components.

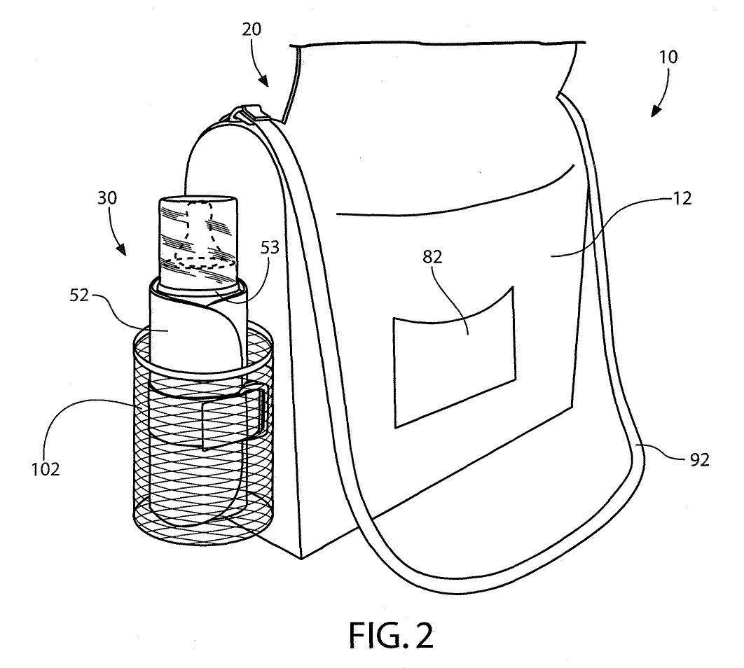

It is further presently preferred that such first housing 12 includes a carrying means 92 disposed thereon for enabling a user to carry such infant care ensemble 10. Preferably, such carrying means is at least one strap as illustrated in FIG. 2.

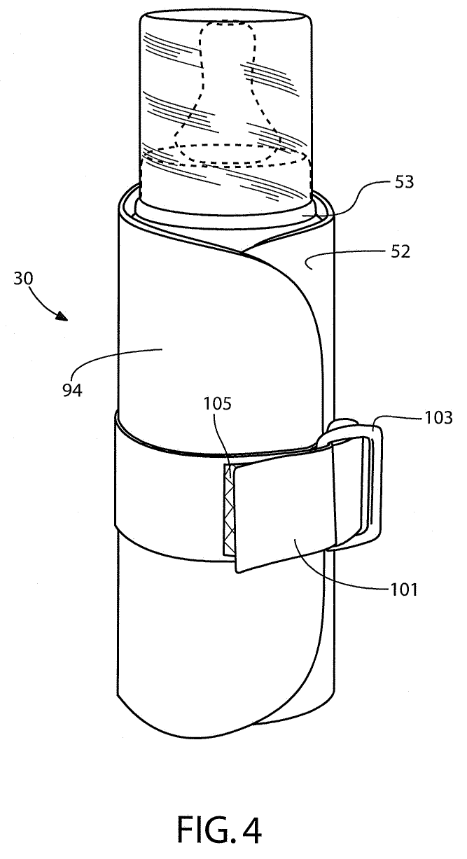

It is presently preferred that such second housing 52 is a substantially rectangular wrap 94 for wrapping around such predetermined lower portion of such predetermined baby bottle 53. Such wrap 94 may include a heating element surrounded by a transfer material suitable to deliver heat to such bottle 53. It is further presently preferred that such wrap 94 further includes a securing means 96 disposed thereon for securing such predetermined lower portion of such predetermined baby bottle 53 within such wrap 94. It is presently preferred that such securing means 96 is at least one of a hook and loop type securing means, a belt type securing means, and a combination thereof. As illustrated in FIG. 4 such securing means 96 is a combination of a hook and loop type securing means and a belt type securing means; a first portion 101 of a hook and loop type belt is shown threaded through a belt buckle 103 and then engaged with a second mating portion 105 of such hook and loop type securing means.

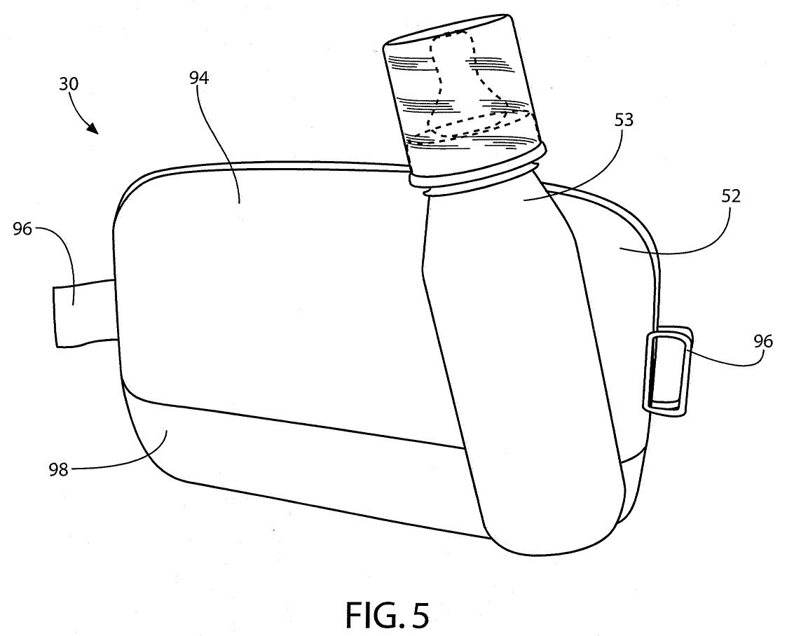

It is also presently preferred that such wrap 94 further includes a pocket member 98 disposed on an interior portion of such wrap 94 closely adjacent a bottom edge thereof for receiving such bottom portion of such predetermined baby bottle 53 prior to such predetermined baby bottle 53 being wrapped within such wrap 94. Such pocket member 98 is illustrated in FIGS. 5, 10, and 11. Such pocket member 98 may take various forms.

It is presently preferred that such first housing 12 further includes a pocket 102 disposed on a predetermined outer side thereof for receiving and storing at least one of such second housing 52, such predetermined baby bottle 53, such predetermined baby bottle 53 disposed within such second housing 52, a predetermined item (not shown), and a combination thereof. As illustrated in FIG. 1 and FIG. 2, such pocket member may be positioned at various locations on such storage member 20 and may consist of a mesh type pocket for receiving various items therein.

It is presently preferred that such first housing 12 of such storage device 20 includes a plurality of storage compartments 82 having a plurality of predetermined shapes and a plurality of predetermined sizes disposed at least one of on and within such first housing 12 at predetermined locations for receiving and storing at least one of such second housing 52, such predetermined infant care items, and a combination thereof. Such predetermined infant care items may be any items desired and/or necessary for the care of an infant and include, but are not limited to, diapers, bottles, baby food, snacks, baby wipes, lotion, shampoo, skin care items, extra clothing, footwear, medicine, a thermometer, toys, teething rings, stuffed animals, blankets, diaper cream, brushes, combs, nail clippers, books, and the like. It is meant that the ensemble take the place of a traditional diaper bag and enable a user to not only carry and store baby care items but to also have the advantage of cooling and heating selected items to provide ultimate comfort to his or her infant as well as enjoy maximum degree of convenience for traveling and the like.

The ensemble is preferably lightweight and collapsible. The storage compartments and pockets of such first housing may includes may also comprise various suitable opening and closure devices such as zippers, buttons, snaps, elastic and like. Such storage compartments may included stretchable pouches, pockets, and the like formed from polymeric mesh or another material familiar to one of ordinary skill in the art. The pockets are meant not only for storing baby care items but also for use in storing items such as cell phones, keys, pens, extra batteries, adapters, and the like, as needed and/or desired by a user. In such manner, such ensemble may not only replace a diaper bag but may also take the place of a user's purse.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An infant care ensemble for storing and transporting infant care items, said infant care ensemble comprising:
(a) a storage device including;
i. a first housing having a first predetermined size and a first predetermined shape for receiving and storing predetermined items therein;
ii. at least one of a cooling means, a first heating means, and a combination thereof disposed at least one of on and within said first housing for at least one of cooling an interior portion of said first housing, warming an interior portion of said first housing, cooling said predetermined items stored within said first housing, warming said predetermined items stored within said first housing, and a combination thereof;
iii. a first power source operably connected to said at least one of said cooling means, said first heating means, and said combination thereof for supplying power thereto;
iv. a first switch means disposed intermediate said first power source and said at least one of said cooling means, said first heating means, and said combination thereof for selectively turning said first power source on and off;
(b) a bottle warming device releasably engageable with such storage device, said bottle warming device including;
i. a second housing having a second predetermined size and a second predetermined shape for housing at least a predetermined lower portion of a predetermined baby bottle;
ii. a second heating means operably disposed at least one of on said second housing, within said second housing, and a combination thereof for heating at least one of an interior portion of said second housing, such predetermined lower portion of such predetermined baby bottle, and a combination thereof;
iii. a second power source operably connected to said second heating means for supplying power thereto; and
iv. a second switch means disposed intermediate said second heating means and said second power source for selectively turning said second power source on and off.

2. The ensemble according to claim 1 wherein said first housing includes a plurality of storage compartments having a plurality of predetermined shapes and a plurality of predetermined sizes disposed at least one of on and within said first housing at predetermined locations for receiving and storing at least one of said second housing, predetermined infant care items, and a combination thereof.

3. The ensemble according to claim 1 wherein said first power source and said second power source are each at least one of AC and DC power.

4. The ensemble according to claim 3 wherein each of said first power source and said second power source is at least one battery.

5. The ensemble according to claim 4 wherein said at least one battery is rechargeable.

6. The ensemble according to claim 5 wherein said ensemble further includes at least one adapter engageable with said at least one battery and at least one of an electrical outlet, an automobile battery, and a combination thereof for recharging said at least one battery.

7. The ensemble according to claim 1 wherein said first housing includes a carrying means disposed thereon for enabling a user to carry said infant care ensemble.

8. The ensemble according to claim 7 wherein said carrying means is at least one strap.

9. The ensemble according to claim 1 wherein said second housing is a substantially rectangular wrap for wrapping around such predetermined lower portion of such predetermined baby bottle.

10. The ensemble according to claim 9 wherein said wrap further includes a securing means disposed thereon for securing such predetermined lower portion of such predetermined baby bottle within said wrap.

11. The ensemble according to claim 10 wherein said securing means is at least one of a hook and loop type securing means, a belt type securing means, and a combination thereof.

12. The ensemble according to claim 9 wherein said wrap further includes a pocket member disposed on an interior portion of said wrap closely adjacent a bottom edge thereof for receiving a bottom portion of such predetermined baby bottle prior to such predetermined baby bottle being wrapped within said wrap.

13. The ensemble according to claim 1 wherein said first housing further includes a pocket disposed on a predetermined outer side thereof for receiving and storing at least one of said second housing, such predetermined baby bottle, such predetermined baby bottle disposed within said second housing, a predetermined item, and a combination thereof.

14. The ensemble according to claim 1 wherein said storage device further includes a first control means disposed on said first housing and operably connected to said at least one of said cooling means, said first heating means, and said combination thereof, said first power source, and said first switch means, for controlling a temperature of at least one of said at least one of said cooling means, said first heating means, and said combination thereof, an interior portion of said first housing, such predetermined items stored within said first housing, and a combination thereof.

15. The ensemble according to claim 14 wherein said bottle warming device further includes a second control means operably connected to said second housing, said second heating means, said second power source, and said second switch means for controlling a temperature of at least one of said second heating means, an interior portion of said second housing, said predetermined portion of said predetermined baby bottle disposed within said second housing, and a combination thereof.

16. The ensemble according to claim 15 wherein said storage device further includes a first timing means disposed on said first housing and operably connected to said at least one of said cooling means, said first heating means, and said combination thereof, said first power source, and said first switch means for automatically turning off power to said at least one of said cooling means, said first heating means, and said combination thereof when a predetermined temperature is reached by at least one of said at least one of said cooling means, said first heating means, and said combination thereof, an interior portion of said first housing, such predetermined items stored within said first housing, and a combination thereof.

17. The ensemble according to claim 16 wherein said storage device further includes a first indicating means disposed on said first housing and operably connected to said at least one of said cooling means, said first heating means, and said combination thereof, said first power source, and said first switch means for indicating that at least one of said at least one of said cooling means, said first heating means, and said combination thereof, and said interior portion of said first housing, such predetermined items stored within said first housing, and a combination thereof has reached said predetermined temperature.

18. The ensemble according to claim 1 wherein said bottle warming device further includes a second timing means operably connected to said second heating means, said second power source, and said second switch means for automatically turning off power to such second heating means when a predetermined temperature has been reached by at least one of said second heating means, an interior portion of said second housing, such predetermined portion of such predetermined baby bottle housed within said second housing, and a combination thereof.

19. The ensemble according to claim 18 wherein said bottle warming device further includes a second indicating means disposed on said second housing and operably connected to said second heating means, said second power source, and said second switch means for indicating that at least one of said second heating means, an interior portion of said second housing, and a combination thereof has reached a predetermined temperature.
